(19) United States
(12) Patent Application Publication
(10) Pub. No.: US 2005/0150964 A1
(43) Pub. Date: Jul. 14, 2005

(54) Counterfeit proof label having optically-concealed cross reference color codes and apparatus for making same

(76) Inventor: Allen K. Lo, Hong Kong (HK)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/034,578

(22) Filed: Jan. 13, 2005

Related U.S. Application Data
(60) Provisional application No. 60/536,542, filed on Jan. 14, 2004.

(51) Int. Cl. G06K 19/06

(52) U.S. Cl. 235/494

(57) ABSTRACT

The prevention of counterfeiting of labels for various products is addressed by introducing counterfeit proof labels having optically-concealed cross reference color codes for identification and verification. Groups of color codes are compressed and printed at the focal plane of a high definition micro-optic arrays of the label in relation to the optical centers of the micro lenses, so that each designated color codes can be read at a specific viewing angle to match with a reference color key on the label for identifying the authentication of the label. All the color codes can be printed on one single label or the cross reference color codes can be printed on the reference label of a twin label system. Both labels will be applied on the product and the color codes on the label can be read under visible light source without any viewing aid.

### CROSS-REFERENCE TO RELATED APPLICATION

This application claims priority to copending U.S. provisional application entitled, “Counterfeit ProofLabel Having Optically-Concealed Cross Reference Color Codes and Apparatus Form Making Same,” having Ser. No. 60/536,542, filed Jan. 14, 2004, which is entirely incorporated herein by reference.

### BACKGROUND OF THE INVENTION

Counterfeiting is a serious problem, despite of the advancement of technology; there is still no practicable solution to prevent counterfeiting effectively, the reasons being that all the labels used on products today can be easily counterfeited and the general consumer cannot positively identify the authenticity of a label.

It is therefore the objective of this invention to provide a counterfeit proof label with multiple security features to maximize the level of preventing counterfeiting. Another objective of this invention is to provide a counterfeit proof label that can be easily and positively identified by the general consumer, still another objective of this invention is to provide a counterfeit proof label that can be further verified by the authorized agent. Still another objective of the invention is to provide a counterfeit proof label with the cross reference color codes that can be read under visible light source by unaided eyes for identification.

There are many advantages of using high definition micro-optic photo chromogenic material for the making of counterfeit proof labels, including:

1. The frequency (number of lenses per inch) of the material can be modified from time to time, making it impossible to duplicate.

2. The color spectrum of the photo chromogenic layer can be modulated from time to time, also making it impossible to duplicate.

3. Ultra high resolution compressed color codes element of 0.005 mm (5 micron) is extremely difficult to reproduced.

4. Many variations of encoding by using millions of combination of color patterns or color density that can be read under visible light source or color spectrum analyzer.

5. The label can be easily and positively recognized and identified by the general consumer.

6. Its optical storage capacity can store and display a great number of images many times larger than its label area.

1. Field of the Invention

The present invention related to counterfeit proof labels having optically-concealed color codes and matching color keys included for identification and authentication, and more specifically, the invention is based upon the use of high definition micro optic photo chromogenic material having large optical storage capacity for storing and displaying a string of cross reference color codes that are readable under visible light source and unaided eyes. This invention also concerns method and apparatus of making such counterfeit proof labels.

2. Disclosure of the Invention

The counterfeit proof label according to the present invention is based upon a code identification and verification by the use of a string of cross reference color codes and matching color keys (patterns) photographically printed at a designated area on the focal plane of an array of micro lenses in relation to its optical axis, so that certain color codes will be displayed at a specific viewing angle of a special sequence on the label. The encoding system includes combination of colors, forms and shapes of color patterns, 2D coordination of colors block and color density etc.

The color codes can be designed as single codes or cross reference codes, all the color codes can be printed on a single label or divided between a set of twin label for cross reference, therefore, increasing the level of security, maximizing the level of anti-counterfeiting. The high definition micro-optic photo chromogenic material is made of high optical grade copolymer, the preferred thickness is between 0.1 mm ˜1 mm with a frequency of between 5 to 30 lenticuler per mm. The Photo chromogenic layer is coated between the focal plane of the micro lenticular and a permeable reflective layer or without a reflective layer.

### BRIEF DESCRIPTION OF THE DRAWINGS

Exemplary embodiments of the invention will be described in conjunction with the drawings in which:

FIG. 1 is a top view of the label viewing from certain angle and displaying one of the many images stored at the focal plane of the label.

FIG. 2 is an enlarged cross-section of a small portion of the label.

FIG. 3 is the compressed color codes arranged and printed on the focal plane of the lenticular of the label, without showing the micro lenticular surface.

FIG. 4 showing the label displaying different images and color codes at a different viewing angle (only a small portion of label is shown)

FIG. 5 example of one of the encode system color codes.

FIG. 6 another example of color codes formation.

FIG. 7 showing a large aperture lens photographic system for making the label.

FIG. 8 showing the different images of the label is exposed through the different small apertures and printed at the different location of the lenticular of the micro-lens material.

FIG. 9 showing color blocks of different forms and shapes.

### DETAILED DESCRIPTION OF THE DRAWING

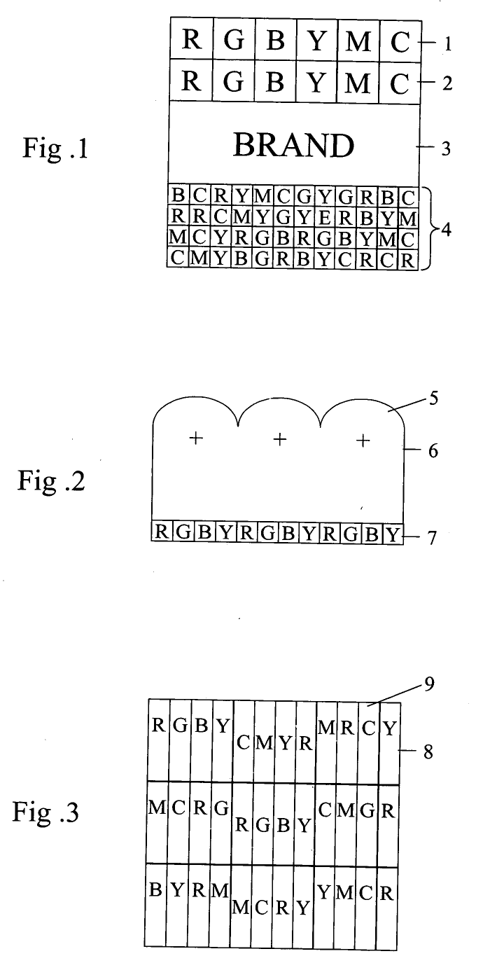

FIG. 1 is the top view of the label (with micro optic surface omitted) viewing from certain angle and only displays one of the many image (graphic and color codes) printed on the focal plane of the lenticular of the label.
1 is a reference color key, the same color patterns are displayed at all viewing angles.
2 is a changing color key, different color combination is displayed at different viewing angles.
3 is the area of the label for printing of the name and information of the product.
4 are groups of color codes related to the product; different codes are displayed at a different angle.

FIG. 2 is an enlarged cross section of a small part of the label
5 is the individual micro lenticular
6 is the optical center of the micro lenticular
7 is the focal plane of the micro lenticular with printed compressed elements of the color codes.

FIG. 3 showing the compressed image element of the color codes of the label with the surface of the micro lenses omitted.
8 is a group of color codes image element
9 is an individual color code image element

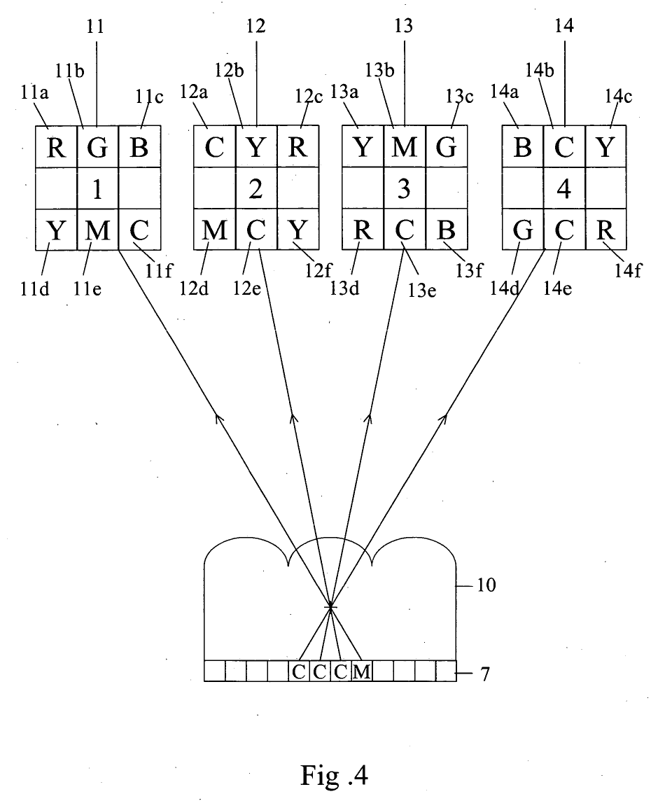

FIG. 4 10 showing an enlarged cross section of a small portion of the label
11˜14 showing a different image and code displayed from different viewing angle, 11a ˜14f are the individual color blocks.

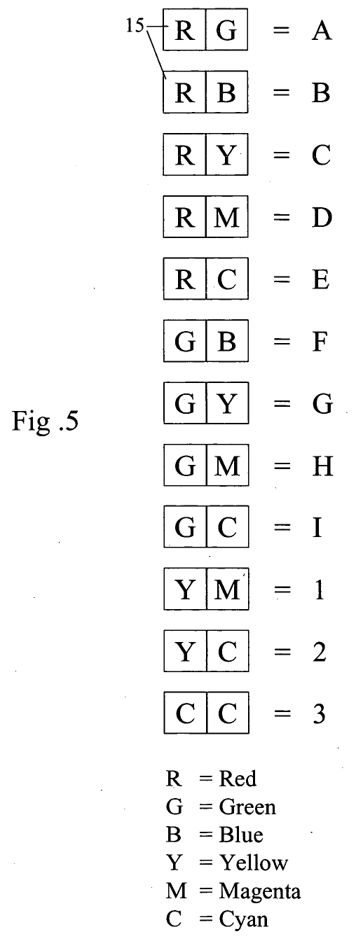

FIG. 5 15 showing codes of the combination of color blocks

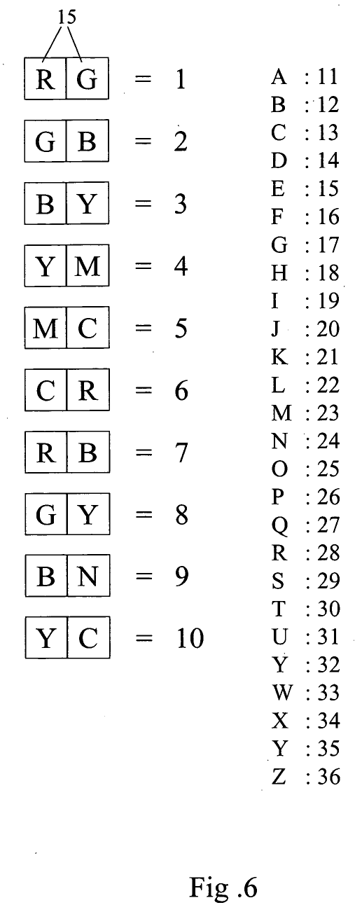

FIG. 6 16 showing codes of the combination of color blocks

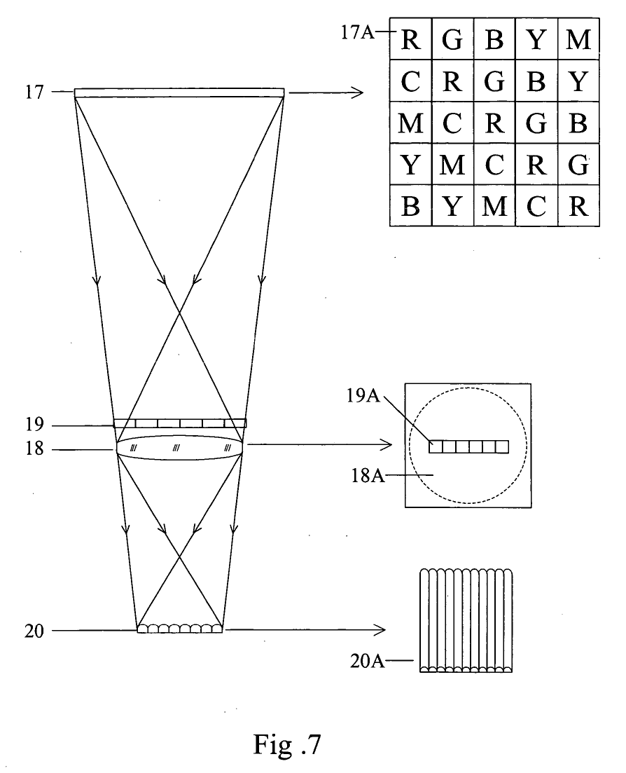

FIG. 7 showing a label printing apparatus
17 & 17A is the top view and front view of the projected image source
18 & 18A is the top view and front view of the large aperture photographic lens
19 & 19A is the top view and front view of the small shutters of the lens
20 & 20A is the top view and front view of the micro optic material

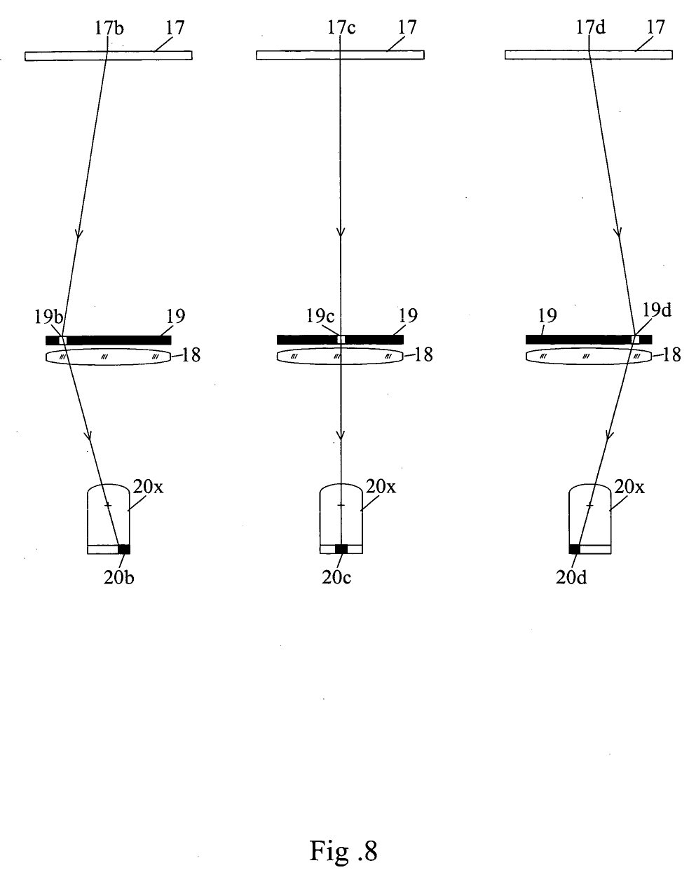

FIG. 8 showing the printing of the different images of the label onto the micro optic material.
17b, 17c and 17d are different image (codes) source displaying on the image device 17 and projected through the small apertures 19b, 19c and 19d of the shutter 19 through large aperture lens 18, the compressed image elements 20b, 20c and
20d are printed at different locations on the photo chromogenic layer of the enlarged cross section of a lenticular 20×of the label.

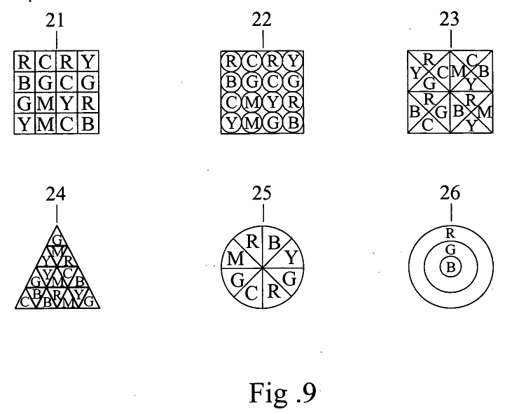

FIG. 9 showing label with color blocks of different forms and shapes 21-26

### EXAMPLE OF THE MANY FORMATIONS OF THE COLOR CODES

1. Combination of color blocks from the same view, FIG. 4, 11a and 11b, 11d and le, etc.

2. Combination of color blocks from different view, FIG. 4, 11a and 12a, 11a and 12b, etc.

3. Combination of color blocks of random locations of the same view, FIG. 4, 11a and 11f, 11c and 11d, etc.

4. Combination of color blocks of random locations of different view, FIG. 4, 11a and 12e, 11f and 14c, etc.

5. Using different forms and shapes of the color blocks 21-26 of FIG. 9.

6. Reading the density of the color blocks.

7. The color codes can be alphabetically encoded, FIG. 5.

8. The color codes can be numerically encoded, FIG. 6.

1. A micro-optical counterfeit proof label having a plurality of security codes in different colors.

2. The micro-optical counterfeit proof label of claim 1, in which the color codes are displayed under lenticules at a plurality of viewing angles in the labels.

3. The micro-optical counterfeit proof label of claim 2, in which the color codes are concealed in the label, and the color codes are arranged so different colors are viewed at different viewing angles.

4. The micro-optical counterfeit proof label of claim 1, in which the formation of the color codes is selected for security reasons from any one or more of the group consisting of:
(a) combination of color blocks from the same view of the label;
(b) combination of color blocks from different views of the label;
(c) combination of color blocks of random locations of the same view;
(d) combination of color blocks of random locations of different views of the label;
(e) any one or more of a plurality of shapes and forms of the color blocks;
(f) any one of more of a plurality of densities of the color of the color blocks;
(g) any one or more of a plurality of graphics or designs of the color blocks for identification purposes;
(h) any one or more of a plurality of color combinations of the various color blocks;
(i) the number of views of the label ranges from 2 to 99.

5. The micro-optical counterfeit proof label of claim 2, in which the material has a frequency of from 5 to 30 lenticules per mm.

6. The micro-optical counterfeit proof label of claim 2, in which the material has a thickness between 0.05 mm and 1 mm.

7. The micro-optical counterfeit proof label of claim 1, in which the label is a single label.

8. The micro-optical counterfeit proof label of claim 1, which comprises twin labels.

9. An apparatus for printing a micro-optical counterfeit proof label having a large aperture lens which has a coverage angle equal to or greater than the viewing angle of the micro lenticules of the micro optical counterfeit proof label.

10. The apparatus of claim 9, in which the large aperture lens has a number of smaller apertures ranges from 2 to 99, in which each small aperture opens and closes in a designed sequence by a single shutter or by a group of independent shutters.

11. A device for displaying projected images of a counterfeit proof label as selected from a group consisting of:
(a) a set of color negatives;
(b) a CRT device;
(c) a LCD device;
(d) a CCD device;
(e) a plasma device;
(f) a LED device;
(g) a fiber optic device.
